(19) United States
(12) Patent Application Publication
(10) Pub. No.: US 2010/0218258 A1
(43) Pub. Date: Aug. 26, 2010

(54) CONTENTS PROTECTION PROVIDING METHOD AND PROTECTED CONTENTS CONSUMING METHOD AND APPARATUS THEREOF

(76) Inventors: Seong-Oun Hwang, Daejon (KR); Sangwoo Ahn, Daejon (KR); Jeho Nam, Seoul (KR); Jin-Woo Hong, Daejon (KR)

Correspondence Address: LADAS & PARRY LLP, 224 SOUTH MICHIGAN AVENUE, SUITE 1600, CHICAGO, IL, 60604, US

(21) Appl. No.: 12/673,820

(22) PCT Filed: Aug. 14, 2008
(86) PCT No.: PCT/KR2008/004725

§ 371 Date: Apr. 22, 2010

Related U.S. Application Data
(60) Provisional application No. 60/956,392, filed on Aug. 17, 2007.
(60) Provisional application No. 60/965,352, filed on Aug. 20, 2007.
(60) Provisional application No. 60/973,431, filed on Sep. 18, 2007.
(60) Provisional application No. 60/982,764, filed on Oct. 26, 2007.
(60) Provisional application No. 60/984,397, filed on Nov. 1, 2007.
(60) Provisional application No. 60/991,844, filed on Dec. 3, 2007.

(51) Int. Cl. G06F 17/00; G06F 15/00

(52) U.S. Cl. 726/26

(57) ABSTRACT

Provided is a contents protection providing method, a protected contents consuming method and an apparatus thereof. The contents protection providing method includes: creating protected scheme information; and transmitting the protected scheme information to a terminal, wherein the protected scheme information includes: scheme type information including identification (ID) information of a protection scheme; and scheme information including detailed information of the protection scheme.

### TECHNICAL FIELD

The present invention relates to a contents protection providing method, a protected contents consuming method and an apparatus thereof.

This work was supported by the IT R&D program for MIC/IITA [2007-S-003-01 “Development of Protection Technology for Terrestrial DTV Program”].

### BACKGROUND ART

As very high-speed Internet comes into wide use and users of digital devices such as a Personal Computer (PC) and a mobile phone increase, problems associated with copyright starts differently from an environment where traditional analog contents are used. In an analog contents environment, copying contents is not easy and effective due to quality degradation. However, development of digital technology and expansion of infrastructure makes illegal copying and mass distribution of digital contents easy.

Problems associated with illegal copying are not limited only to Internet and a PC environment. As all media are being digitalized, the illegal copying and mass distribution of digital contents have become problems to be solved in both broadcasting and non-broadcasting areas.

There are Digital Rights Management (DRM) and copy protection technologies as conventional technical measures for solving these problems. However, effective solutions for preventing the illegal copying and mass distribution of digital contents are not suggested yet.

### DISCLOSURE

### Technical Problem

An embodiment of the present invention is directed to providing a method and apparatus for efficiently protecting digital contents from being illegally copied and distributed in mass.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a contents protection providing method, including: creating protected scheme information; and transmitting the protected scheme information to a terminal, wherein the protected scheme information includes: scheme type information including identification (ID) information of a protection scheme; and scheme information including detailed information of the protection scheme.

In accordance with another aspect of the present invention, there is provided a protected contents consuming method, including: receiving protected scheme information; and consuming protected contents based on the protected scheme information, wherein the protected scheme information includes: scheme type information including ID information of a protection scheme; and scheme information including detailed information of the protection scheme.

In accordance with another aspect of the present invention, there is provided a contents protection providing apparatus, including: a creating unit for creating protected scheme information; and a transmitting unit for transmitting the protected scheme information to a terminal, wherein the protected scheme information includes: scheme type information including ID information of a protection scheme; and scheme information including detailed information of the protection scheme.

In accordance with another aspect of the present invention, there is provided a protected contents consuming apparatus, including: a receiving unit for receiving protected scheme information; and a consuming unit for consuming protected contents based on the protected scheme information, wherein the protected scheme information includes: scheme type information including identification (ID) information of a protection scheme; and scheme information including detailed information of the protection scheme.

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

### ADVANTAGEOUS EFFECTS

The present invention can efficiently prevent illegal copying and mass distribution of digital contents.

### BRIEF DESCRIPTION OF THE DRAWINGS

FIG. 1 is a block diagram showing protected scheme information in accordance with an embodiment of the present invention.

FIG. 2 is a block diagram showing a contents protection providing apparatus and a protected contents consuming apparatus in accordance with an embodiment of the present invention.

FIG. 3 is a block diagram showing a structure of an International Organization for Standardization (ISO) base media file in accordance with an embodiment of the present invention.

FIG. 4 is a block diagram showing a track and sample of an ISO base media file format in accordance with an embodiment of the present invention.

### BEST MODE FOR THE INVENTION

A detailed embodiment of the present invention will be described hereafter.

### Embodiment

In the embodiment of the present invention, a method for protecting contents of International Organization for Standardization (ISO) base media file format generally used not only on the Internet but also in a broadcasting environment will be described. The contents protection method suggested in the present invention can be applied to fields using the ISO base media file format as well as a broadcasting field. In other words, the application area of the present invention is not specifically limited to a contents field.

In this embodiment, a case that the present invention protects a broadcasting program based on Digital Video Broadcasting (DVB) Content Protection and Copy Management (CPCM) in a Moving Picture Experts Group 2 Transport Stream (MPEG-2 TS) broadcasting environment will be described.

ISO base media file format [ISO/IEC 14496-12: Information technology—Coding of audio-visual objects—Part 12: ISO Base Media File Format, Second Edition, April 2005] describes a general format for other specific file formats.

A core concept of the ISO base media file format will be described in brief.

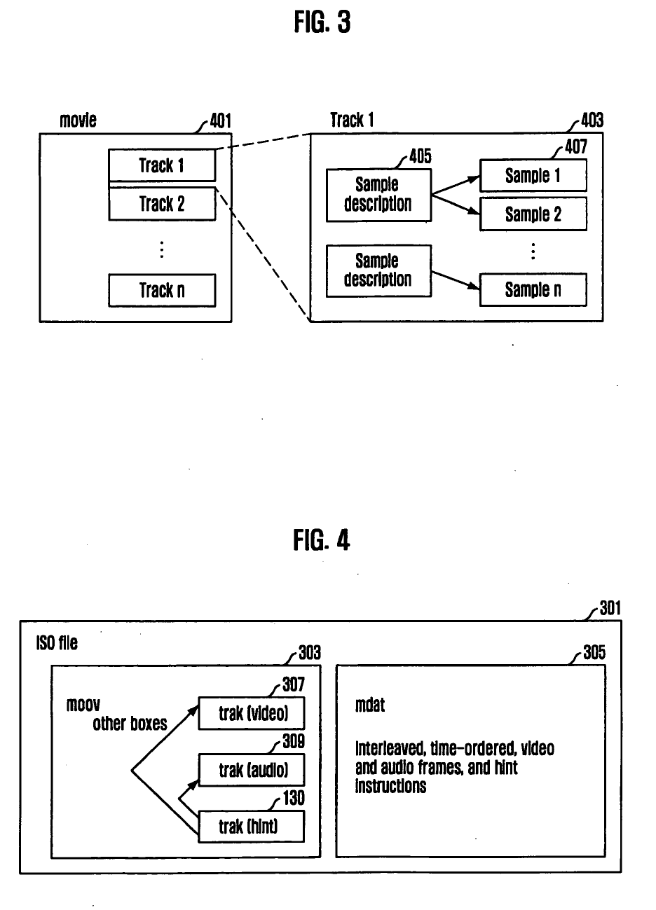

FIG. 3 is a block diagram showing a structure of the ISO base media file used in accordance with an embodiment of the present invention. Referring to FIG. 3, an ISO base media file 301 includes objects called ‘boxes 303 and 305’ and the entire data are described in the boxes.

A box object has size and type information. The size indicates the size of the data included in the box as a byte number and the type means a box identifier formed of 4 letters. Accordingly, the location of the box including desired information can be easily detected based on the size and type information.

A moov 303 and A mdat 305 of FIG. 3 are boxes having metadata and media data, respectively. The metadata do not include media data and are just referred to for description. The ISO base media file has a box of a ‘moov’ type including metadata on media stream and a box of a ‘mdat’ type including actual media data.

FIG. 4 is a block diagram showing a track and sample of the ISO base media file format in accordance with an embodiment of the present invention. In FIG. 4, a movie 401 is a set of consecutive motions where video such as moving picture is integrated with audio. A track 403 shows a time flow of the media and includes a sample 407 and a sample description 405. The sample 407 means a small unit such as a frame of video and the sample description 405 defines information on how the samples 407 are decoded. There are a video track, an audio track and a hint track as the kind of tracks. The video track or the audio track includes metadata on video or audio. The hint track describes information on how a streaming server performs streaming or packetizing onto video and audio samples when the ISO base media file is streamed based on a streaming protocol. When the ISO base media file is restored, the hint track may be ignored.

MPEG is a standard protocol made by the International Standard Organization/International Electro-technical Commission (ISO/IEC) Joint Technical Committee One (JTC1) affiliated committee SC29/WG11, which is related to general technology for compressing, coding and transmitting multimedia data such as moving pictures and voice signals. MPEG-2 is a more generalized standard protocol ISO/IEC 13818 made in 1995, and it is suggested for applying the video and audio technology to communication and broadcasting media as well as storing video in digital storage such as compact disc (CD) and video tape recorder (VTR). MPEG-2 Transport Stream (TS) is a packetizing procedure of MPEG-2 for configuring a plurality of broadcasting programs into a multiplexed stream under a channel environment having an error and transmitting or broadcasting the stream through network. The MPEG TS packet is a 188-byte fixed length packet and the consecutive streams of the TS packet are called Transport Stream (TS).

In the embodiment of the present invention, a broadcasting program as contents protected by Digital Video Broadcasting Content Protection Copy Management (DVB-CPCM), which is a contents protection system regulated in DVB based on the ISO media base file format, will be described. A mechanism used for signaling CPCM protection of an MPEG-2 TS reception hint track and transmitting contents license related to protection will be described in detail hereinafter.

‘ench’ is used as a sample entry type of an MPEG-2 TS reception hint track to show the hint track.

In the ISO base media file format [ISO/IEC 14496-12: Information technology—Coding of audio-visual objects—Part 12: ISO Base Media File Format, Second Edition, April 2005], ‘encv’, ‘enca’, ‘enct’, and ‘encs’ are defined and used in case of a video, an audio, a text and a system, respectively.

In order to show the type of a protection scheme, e.g., CPCM, the contents are protected under, a protected scheme information box is defined and used in the ISO base media file. The protected scheme information box includes a plurality of subordinate boxes. The subordinate box includes an original format box, a scheme type box and a scheme information box.

The original format box includes original format information, which is format information on an original copy before the protection scheme is applied. That is, the original format box stores contents type information before the contents are formed in a protected type. For example, in order to show that MPEG-2 TS reception hint track is unencrypted, 4-letter code ‘m2ts’ is used in a predetermined field data_format of the original format box.

The scheme type box includes scheme type information including identification (ID) information of the protection scheme. That is, the scheme type box includes information on which protection scheme the contents are stored in.

The scheme type box includes protection scheme type information “scheme_type” and protection scheme version information “scheme_version”. The protection scheme type information stores a code value of the protection scheme and the protection scheme version information stores file format encapsulation version information of the scheme. For example, in case of CMCP, the protection scheme type information stores ‘cpcm’ and the protection scheme version information stores the version information of the protection scheme.

The scheme type box includes Uniform Resource Identifier (URI) information “scheme_uri” for connecting the user to a web page when the protection scheme is not installed in the oldest compatible version information of the protection scheme “oldest_compatible_version” or a system.

The scheme information box includes scheme information including detailed information of the protection scheme. The scheme information box includes information defined and used only in the protection scheme. In this case, the scheme information box is analyzed by the protection scheme used to protect the contents or the file.

The scheme information box includes license information of the contents. For example, in case of CMCP, the scheme information box includes a CMCP license box. The CPCM License Box includes license information that a protection system following CPCM is capable of analyzing. Decoding key information is included in the license so that only the user acquiring the license can decode a coded track. A syntax of the CPCM license box is as follows.

```
    class CPCMLicenceBox extends FullBox(‘clic’, version,
flags) {
    if (version == 0) {
    unsigned int(8) cpcm_licence_data[ ];
    } else {
    unsigned int(8) reserved[ ];
    }
    }
    where ‘cpcm_licence_data’ includes binary data of an
actual CPCM contents license.
```

The protected scheme information box may further include an additional data box. The additional data box includes additional data information or identifier information of a metadata item including the additional data information. The additional data box may be a part of the ‘moov’ box.

```
    class CPCMAuxiliaryData extends FullBox(‘caux’, version,
flags) {
    if (version == 0) {
    if (flags & 1) {
    unsigned int(8) cpcm_auxiliary_data[ ];
    } else {
    unsigned int(32) cpcm_auxiliary_data_metadata_item_id;
    }
    } else {
    unsigned int(8) reserved[ ];
    }
    }
```

As described above, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art, further description will not be provided herein.

While the present invention has been described with respect to certain preferred embodiments, it will be apparent to those skilled in the art that various changes and modifications may be made without departing from the scope of the invention as defined in the following claims.

### MODE FOR THE INVENTION

Following description exemplifies only the principles of the present invention. Even if they are not described or illustrated clearly in the present specification, one of ordinary skill in the art can embody the principles of the present invention and invent various apparatuses within the concept and scope of the present invention. The use of the conditional terms and embodiments presented in the present specification are intended only to make the concept of the present invention understood, and they are not limited to the embodiments and conditions mentioned in the specification.

In addition, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flowcharts, state conversion diagrams, pseudo codes and the like can be expressed substantially in a computer-readable media, and whether or not a computer or a processor is described distinctively, they should be understood to express various processes operated by a computer or a processor.

Functions of various devices illustrated in the drawings including a functional block expressed as a processor or a similar concept can be provided not only by using hardware dedicated to the functions, but also by using hardware capable of running proper software for the functions. When a function is provided by a processor, the function may be provided by a single dedicated processor, single shared processor, or a plurality of individual processors, a part of which can be shared.

The apparent use of a term, ‘processor’, ‘control’ or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

In the claims of the present specification, an element expressed as a means for performing a function described in the detailed description is intended to include all methods for performing the function including all formats of software, such as combinations of circuits for performing the intended function, firmware/microcode and the like. To perform the intended function, the element is cooperated with a proper circuit for performing the software. The present invention defined by claims includes diverse means for performing particular functions, and the means are connected with each other in a method requested in the claims. Therefore, any means that can provide the function should be understood to be an equivalent to what is figured out from the present specification.

The advantages, features and aspects of the invention will become apparent from the following description of the embodiments with reference to the accompanying drawings, which is set forth hereinafter. Therefore, those skilled in the field of this art, of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

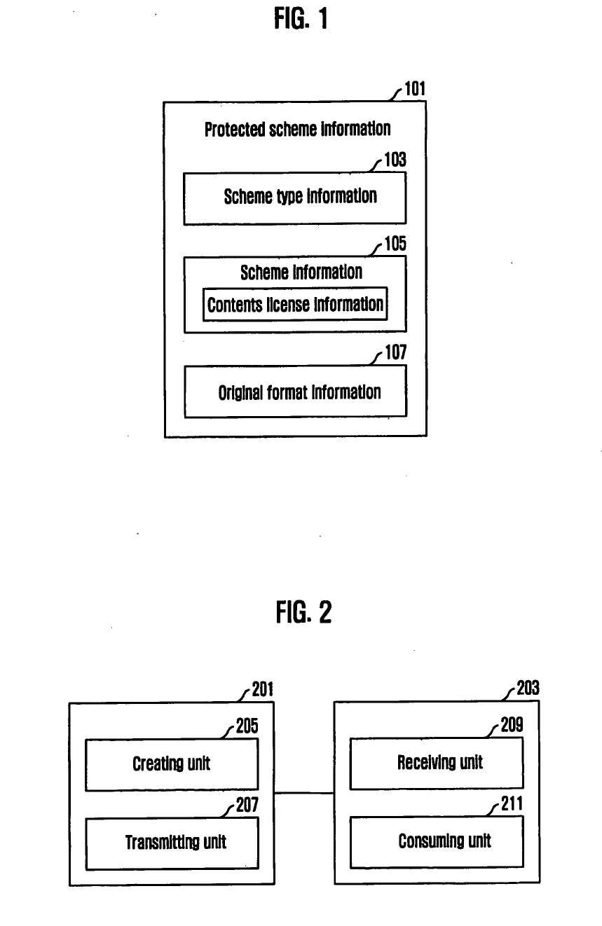

FIG. 1 is a block diagram showing protected scheme information in accordance with an embodiment of the present invention. The protected scheme information 101 in accordance with the present invention is information used to protect contents. The protected scheme information 101 includes scheme type information including identification (ID) information of a protection scheme and scheme information including detailed information of the protection scheme.

The protection scheme is a scheme for protecting contents and includes a scheme for encoding contents. The contents include metadata describing information on media data or contents such as an audio or a video. Accordingly, illegal copying and mass distribution of digital contents can be efficiently prevented by effectively corresponding to the protection schemes which are different according to service providers.

The protected scheme information further includes original format information, which is format information on an original copy before the protection scheme is applied.

The scheme type information includes the protection scheme type information and the protection scheme version information.

The scheme information includes contents license information. Also, the scheme information includes additional data information or identifier information of metadata on the additional data information.

The protected scheme information is defined as an International Organization for Standardization (ISO) base media file format and a protection scheme is a scheme for protecting a reception hint track.

The present invention is realized as methods including a contents protection providing method and a protected contents consuming method, or realized as apparatuses including a contents protection providing apparatus and a protected contents consuming apparatus. The methods and apparatuses realized by the present invention will be described hereinafter.

<Contents Protection Providing Method and Protected Contents Consuming Method>

The present invention is realized in a system including a contents protection provider and a terminal receiving contents.

The contents protection providing method and the protected contents consuming method respectively performed in the provider and the terminal will be described.

The contents protection providing method in accordance with the present invention includes procedures of creating protected scheme information and transmitting the protected scheme information to the terminal. The protected scheme information includes scheme type information including ID information of the protection scheme and scheme information including detailed information of the protection scheme. The protected scheme information further includes original format information, which is format information on an original copy before the protection scheme is applied.

The scheme type information includes the protection scheme type information and version information and the scheme information includes license information of contents. Also, the scheme information includes additional data information or identifier information of metadata on the additional data information. The protected scheme information is defined as an ISO base media file format and the protection scheme is a scheme for protecting a reception hint track.

The protected contents consuming method in accordance with the present invention includes procedures of receiving protected scheme information and consuming protected contents based on the protected scheme information. The protected scheme information includes scheme type information including ID information of the protection scheme and scheme information including detailed information of the protection scheme. The protected scheme information further includes original format information, which is format information on an original copy before the protection scheme is applied.

The scheme type information includes type information and version information of the protection scheme and the scheme information includes license information of the contents. Also, the scheme information includes additional data information or identifier information of metadata on the additional data information. The protected scheme information is defined as an ISO base media file format and the protection scheme is a scheme for protecting a reception hint track.

<Contents Protection Providing Apparatus and Protected Contents Consuming Apparatus>

The present invention is realized as a system including a contents protection provider and a terminal receiving contents. FIG. 2 is a block diagram showing the contents protection providing apparatus and the protected contents consuming apparatus in accordance with an embodiment of the present invention. It will be described with reference to FIG. 2.

The contents protection providing apparatus in accordance with the present invention includes a creating unit for creating protected scheme information and a transmitting unit for transmitting the protected scheme information to the terminal. The protected scheme information includes scheme type information including ID information of the protection scheme and scheme information including detailed information of the protection scheme. The protected scheme information further includes original format information, which is format information on an original copy before the protection scheme is applied.

The scheme type information includes type information and version information of the protection scheme and the scheme information includes license information of contents. Also, the scheme information includes additional data information or identifier information of metadata on the additional data information. The protected scheme information is defined as an ISO base media file format and the protection scheme is a scheme for protecting a reception hint track.

The protected contents consuming apparatus in accordance with the present invention includes a receiving unit for receiving protected scheme information and a consuming unit for consuming protected contents based on the protected scheme information. The protected scheme information includes scheme type information including ID information of the protection scheme and scheme information including detailed information of the protection scheme. The protected scheme information further includes original format information, which is format information on an original copy before the protection scheme is applied.

The scheme type information includes type information and version information of the protection scheme and the scheme information includes license information of the contents. Also, the scheme information includes additional data information or identifier information of metadata on the additional data information. The protected scheme information is defined as an ISO base media file format and the protection scheme is a scheme for protecting a reception hint track.

### INDUSTRIAL APPLICABILITY

The present invention is applied to efficiently prevent illegal copying and mass distribution of digital contents.

1. A contents protection providing method, comprising:
creating protected scheme information; and
transmitting the protected scheme information to a terminal,
wherein the protected scheme information includes:
scheme type information including identification (ID) information of a protection scheme; and
scheme information including detailed information of the protection scheme.

2. The method of claim 1, wherein the protected scheme information further includes original format information, which is format information on an original copy before the protection scheme is applied.

3. The method of claim 1, wherein the scheme type information includes type information and version information of the protection scheme.

4. The method of claim 1, wherein the scheme information includes license information of contents.

5. The method of claim 4, wherein the scheme information includes additional data information or identifier information of metadata on the additional data information.

6. The method of claim 1, wherein the protected scheme information is defined as an International Organization for Standardization (ISO) base media file format and the protection scheme is a scheme for protecting a reception hint track.

7. A protected contents consuming method, comprising:
receiving protected scheme information; and
consuming protected contents based on the protected scheme information,
wherein the protected scheme information includes:
scheme type information including identification (ID) information of a protection scheme; and
scheme information including detailed information of the protection scheme.

8. The method of claim 7, wherein the protected scheme information further includes original format information, which is format information on an original copy before the protection scheme is applied.

9. The method of claim 7, wherein the scheme type information includes type information and version information of the protection scheme.

10. The method of claim 7, wherein the scheme information includes license information of contents.

11. The method of claim 10, wherein the scheme information includes additional data information or identifier information of metadata on the additional data information.

12. The method of claim 7, wherein the protected scheme information is defined as an International Organization for Standardization (ISO) base media file format and the protection scheme is a scheme for protecting a reception hint track.

13-24. (canceled)
